(19) United States
(12) Patent Application Publication
(10) Pub. No.: US 2004/0172631 A1
(43) Pub. Date: Sep. 2, 2004

(54) Concurrent-multitasking processor

(76) Inventor: James E Howard, Portland, OR (US)

Correspondence Address: William O Geny, Chernof Vilhauer McClung Stenzel, 1600 Ods Tower, 601 SW Second Avenue, Portland, OR, 97204-3157, US

(21) Appl. No.: 10/477,806

(22) PCT Filed: Jun. 20, 2001
(86) PCT No.: PCT/US01/41065

(51) Int. Cl. G06F 9/46

(52) U.S. Cl. 718/100

(57) ABSTRACT

A concurrent multitasking processor for a real-time operating system (RTOS) device includes a plurality of execution units for executing a plurality of tasks simultaneously and a task selector for comparing priorities of a plurality of tasks and for selecting one or more high priority tasks requesting execution. An instruction fetcher fetches instructions from memory for the tasks selected by the task selector and stores the instructions for each task in one or more instruction queues. An instruction issue unit attaches priority tags to instructions and sends instructions from the instruction queues to a plurality of execution units for execution.

### TECHNICAL FIELD

Superscalar microprocessors perform multiple tasks concurrently. When tied to a real-time operating system, such processors must execute multiple tasks simultaneously or nearly simultaneously. This type of architecture provides multiple execution units for executing multiple tasks in parallel. The multiple tasks are defined by coded instruction streams all of which vie for the processor's ability to execute at any given time.

### BACKGROUND ART

Inefficiency occurs in the use of computer execution resources when instruction streams do not make full use of available execution circuitry. Typically, these inefficiencies are caused by latencies (such as cache misses, branches, or memory page faults), unoptimized instruction sequences, exceptions, blockages of instruction streams due to resource delays, and other complications.

U.S. Pat. No. 5,867,725 to Fung et al. discloses concurrent multitasking in a uniprocessor. The Fung et al. patent uses the thread number of a task to track a multiplicity of tasks through execution units. Fung et al. however include no means for allocating tasks to execution units based upon priority of the task, task initiation driven by interrupts or a real-time operating system (RTOS) kernel in its hardware. Thread initiation in Fung et al. requires software to split a single task into multiple threads which is too slow and impractical for an RTOS. This mechanism is appropriate only for specially compiled programs. There is no means for using the Fung et al. system in the real-time world of rapid interrupts, large numbers of ready to run tasks, priority ramping, and deadline scheduling. Instead, inefficient software must be used to switch threads and tasks spending hundreds of thousands of clock cycles per interrupt and task change thus limiting interrupt response rate. This, in turn, requires large memory buffers to accommodate the low interrupt rate.

### DISCLOSURE OF THE INVENTION

Typically, superscalar processors issue instructions from a single instruction stream. In contrast, the invention substantially increases the efficiency of processor utilization by issuing instructions from one or more additional instruction streams on a prioritized basis whenever unused execution capacity is available, thereby increasing throughput by making use of the maximum capability of the processing circuitry. Higher priority tasks are given first choice of resources, thereby assuring proper sequences of task completions.

Instruction streams can come from one or more tasks or threads or from one or more co-routines or otherwise independent instruction streams within a single task or thread. The instruction streams are fetched from the instruction memory or cache, either serially for one stream at a time, or in parallel for more than one stream at a time, and sent to one or more instruction queues. If more than one instruction queue is used, each instruction queue typically contains instructions which are independent with respect to all the other instruction queues. Instructions are decoded by one or more attached instruction decoders for each instruction queue. Instructions are issued from the decoders to one or more execution units in order of priority of the instruction streams. The highest priority instruction stream gets priority for the use of the available execution units and the next lower-priority instruction stream issues instructions to the remaining available execution units. This process continues until instructions have been issued to all execution units, until there are no execution units available for processing any of the queued instruction functions, or until there are no more instructions available for issue.

When instruction streams are blocked from issuing instructions, they can be removed from their instruction queues and other instruction streams may be assigned to those queues. Blockages can occur when instruction stream addresses are altered by branches, jumps, calls, returns and other control instructions, or by interrupts, resets, exceptions, trap conditions, resource unavailability, or a multitude of other blocking circumstances. Thus when confronted by blockages, the invention permits continuous issuances of instructions to maximize throughput while blocked instruction streams wait for resources.

In order to process instruction streams in the execution units, the processor is provided with a register memory that holds the contents of the instruction stream register sets. Register locations within the register memory are dynamically assigned to registers in the high-speed register rename cache as necessary for each instruction stream by a priority-based issue controller. Information from the register memory is loaded into the assigned rename cache registers for processing. This allows for high-speed instruction stream processing while lower-speed high-density memory can be used for massive storage of register contents. This process of register assignment prevents register contention between instruction streams. When instruction streams require register allocation and all rename cache registers are currently allocated, least-recently-used rename cache registers are reassigned to the new instruction streams. At this time, rename cache register contents are exchanged to and from the appropriate locations in register memory.

The processor uses a hardware-based Real Time Operating System (RTOS) and Zero Overhead Interrupt technology, such as is presented in U.S. Pat. No. 5,987,601. The use of hardware prioritized task controllers in conjunction with variable hardware ramping-priority deadline-timers for each task internal to the processor eliminates instruction overhead for switching tasks and provides a substantial degree of increased efficiency and reduced latency for multi-threading and multi-task processing. This technology provides for as many as 256 or more tasks to run concurrently and directly from within the processor circuitry without the need to load and unload task control information from external memory. Therefore, high priority task interrupt processing occurs without overhead and executes immediately upon recognition. Multiple task instruction streams of various priority levels may execute simultaneously within the execution units.

### BRIEF DESCRIPTION OF THE DRAWINGS

FIG. 1 is a schematic block diagram of the concurrent multitasking processor of the invention.

FIG. 2 is a flow chart diagram illustrating the operation of the concurrent multitasking processor of FIG. 1.

FIG. 3 is a schematic diagram illustrating the operation of the semaphore circuit with respect to task control storage.

### BEST MODES FOR CARRYING OUT THE INVENTION

Within the preferred embodiment, a task is an independent hardware and software environment containing its own instructions, instruction execution address (program counter), general-purpose registers, execution control registers, and priority and other control and storage elements that share processing resources with other tasks in this computer system. 256 tasks are implemented in hardware with software providing the support for an essentially unlimited plurality of additional tasks. Run, sleep, active, defer, interrupt, suspended, round-robin, and other status and control bits are maintained for each task.

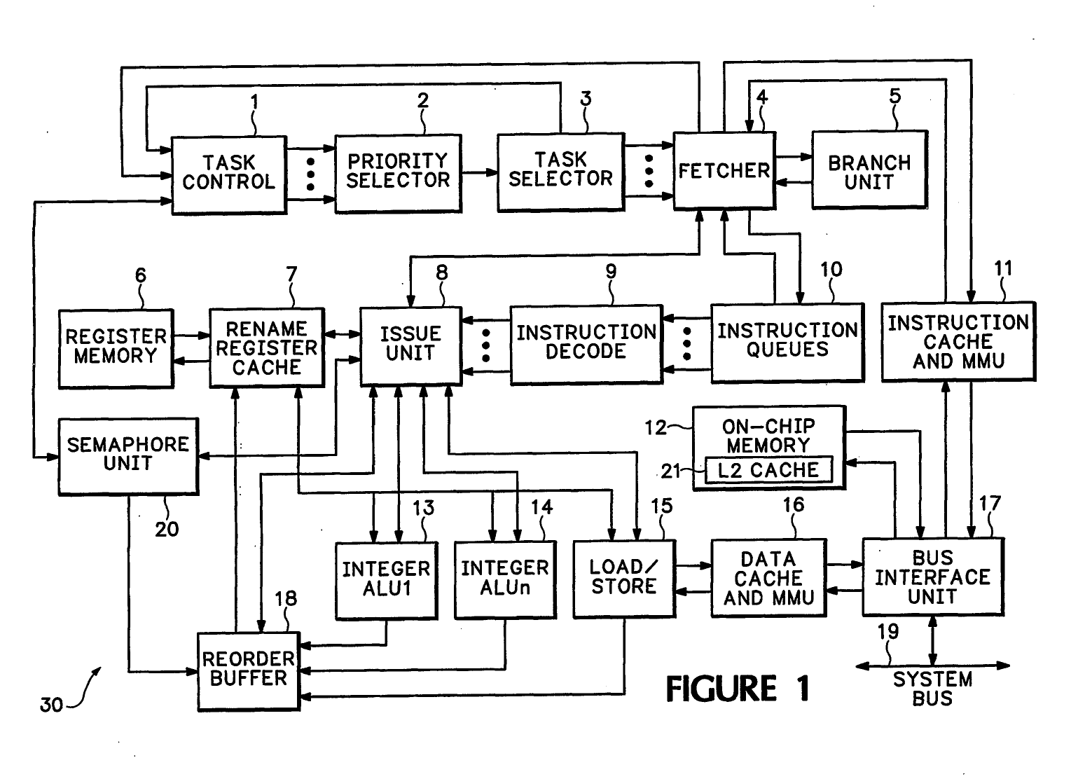

With reference to FIG. 1, processor 30, a block diagram of a processor for processing information according to a preferred embodiment of the present invention is illustrated. The diagram comprises a single integrated circuit superscalar microprocessor capable of executing multiple instructions per processor cycle. Accordingly as discussed further below, the processor includes various execution units, registers, buffers, memories, and other functional units which are all formed by integrated circuitry.

As depicted in FIG. 1, processor 30 is coupled to system bus 19 via a bus interface unit (BIU) 17 within processor 30. The system of which bus 19 is a part is a real time operating system (RTOS). BIU 17 controls the transfer of information between processor 30 and other devices coupled to system bus 19, such as a main memory (not illustrated). Processor 30, system bus 19, and the other devices coupled to system bus 19 together form a host data processing system. BIU 17 is connected to instruction cache and MMU 11, data cache and MMU 16, and on-chip memory 12 with L2 Cache 21 within processor 30. High speed caches, such as instruction cache 11 and data cache 16, enable processor 30 to achieve relatively fast access time to a subset of data or instructions previously transferred from main memory to the high speed caches, thus improving the speed of operation of the host data processing system. Instruction cache 11 is further coupled to fetcher 4 which fetches instructions from instruction cache 11 and places them into instruction queues 10 for execution. On-chip memory 12 provides high-speed random access memory for general-purpose use and for use by L2 cache 21. Temporary storage of instruction streams and data for the instruction and data caches is provided by L2 cache 21.

Task control 1 contains storage and control registers for a plurality of tasks. Each task is provided at least one apiece of the following registers: instruction execution address (program counter), priority, execution control, memory access descriptor, and such additional control and storage elements as are required. Task control 1 transfers the priority, task number, and a copy of the instruction execution address for each task to priority selector 2. 256 priority levels are implemented with a priority level of zero representing the lowest priority. Tasks with priority level of zero are not permitted to execute, and this priority level is also used to represent a non-execution request condition. The priority levels are set to an initial value stored in a lower-limit register for each task and are increased as time elapses to a maximum value stored in an upper-limit register for each task. The rate of increase is controlled by a ramp-time register for each task. Priority levels can be boosted by semaphore unit 20 to assure that lower priority tasks owning the semaphore are allowed to continue execution at the priority level of the semaphore requesting task, thus preventing higher priority tasks requesting the semaphore from deadlock (waiting for a low priority task that may never get execution time). A boost register is maintained for each task to facilitate the boosting of priority changes. Semaphore number, priority and sequence registers are maintained for each task. These registers are accessed by semaphore unit 20 to process the blocked-on-semaphore queues. A semaphore timeout counter is maintained for each task to prevent, upon such options as may be selected or controlled, stalling a task waiting for a semaphore.

Each task implements an interrupt attachment mechanism which can connect any interrupt source in the processor to the task. The interrupt is used to change the instruction execution address of an executing task or to wake up a sleeping task and cause it to execute. Each task incorporates a defer counter which may be enabled by program control if desired. Its function is to count interrupts and defer the wake up until a programmed number of interrupts have been received. This mechanism may be used for precise timing, FIFO flow control, and other purposes where additional delay time is desired for repetitive interrupts.

Priority Selector 2 selects the requesting task with the highest priority by comparing the priorities of the tasks requesting instruction execution. It then transfers the highest-priority task number, its priority level, and its instruction execution address register to task selector 3.

Task selector 3 receives the current highest-priority requesting task number, priority and instruction execution address from priority selector 2. Task selector 3 saves the task number, priority and instruction execution address for a plurality of the highest-priority tasks. Task selector 3 sends an acknowledge signal to the selected highest-priority task in Task control 1 that disables its request priority. This allows other tasks of equal or lower priority to be selected by priority selector 2. The task selector transfers the saved task number, priority and instruction execution address for a plurality of tasks to fetcher 4.

Tasks with equal priority are selected by task selector 3 to execute in a round-robin sequence. Task selector 3 contains a programmable timer which causes the oldest equal-priority task to be replaced by a new equal-priority task. When this occurs, task selector 3 sends a signal to Task control 1 in order to set the round-robin flag in the old task, thus causing it to disable its request priority. When a lower-priority request (or none) is received from priority selector 2 indicating that there are no more tasks requesting with the current priority level, task selector 3 sends a signal to Task control 1 to clear all the round-robin flags at the current round-robin priority level.

Fetcher 4 assigns a unique instruction stream number to each task selected by task selector 3. Instruction stream numbers are used to insure the in-order retiring of instructions. Each time a task is deselected and reselected by task selector 3, fetcher 4 assigns a new instruction stream number to the task. Fetcher 4 assigns instruction streams to the instruction queues 10. When changing instruction streams for an instruction queue, the instruction queue is flushed. Fetcher 4 receives the selected tasks' instruction addresses and maintains the current instruction addresses for the selected tasks. When a task is no longer selected by task selector 3, the current instruction execution address for the task is sent from fetcher 4 to Task control 1, updating the task's instruction execution address. Fetcher 4 fills empty or partially empty instruction queues 10 from instruction cache 11 or from branch unit's 5 branch target buffer in highest-priority order. Fetcher 4 updates the current instruction execution address for each instruction stream as instructions are issued or branches are taken. Fetcher 4 transmits the task numbers, priorities, memory access descriptors, instruction stream numbers, and the instruction-queue-assignment correlation information on to issue unit 8.

Branch instructions are identified and removed from the instruction streams by fetcher 4 prior to being placed into the instruction queues, and are sent to branch unit 5 for execution.

Branch unit 5 executes branch instructions, which change the sequence in which the instructions in the computer program are performed, and performs static and dynamic branch prediction on unresolved conditional branches to allow speculative instructions to be fetched and executed. Instructions issued beyond a predicted branch do not complete execution until the branch is resolved, preserving the programming model of sequential execution. A branch target buffer supplies a plurality of instructions at the predicted branch addresses to fetcher 4 which forwards them to instruction queues 10.

Instruction queues 10 consists of two or more instruction queues that are used to store two or more instruction streams from which instructions are issued for execution. Each instruction queue holds one or more instructions from a single instruction stream identified by a unique instruction stream number. The instruction queues 10 serve as a buffer between the instruction cache 11 and the instruction decoders in decoder 9. Issued instructions are removed from the instruction queues 10. The instruction queue length is greater than one cache line length to allow for background refill of the instruction queue. Each instruction queue provides access to a plurality of instructions by instruction decode 9. All of the instruction queues forward instructions and instruction stream numbers simultaneously to decode 9.

Instruction decode 9 provides two or more instruction decoders for each instruction queue. The decoded instructions and instruction stream numbers are forwarded simultaneously to instruction issue 8 which uses this information to select instructions for execution by priority and the availability of execution resources.

Issue unit 8 simultaneously issues instructions from one or more instruction decoders to the integer ALUs 13 and 14, load/store unit 15 and semaphore unit 20. Issued instructions are accompanied by their rename source and destination register numbers and their instruction priorities. Memory access descriptors are also issued to load/store unit 15 for memory access instructions. Task numbers are issued only to semaphore unit 20 along with priority levels for semaphore instruction execution. To support maximum throughput, instructions are issued from a plurality of instruction streams out of program order when no instruction dependencies are violated. Dependency checking is performed by issue 8 and instructions can be issued out of order if there is no dependency conflict. Multiple instructions from the highest-priority task's instruction stream are issued whenever possible. Additionally, multiple instructions are issued from the lower-priority tasks' instruction streams for any remaining available execution units. Issue unit 8 allocates a storage location in the reorder buffer 18 for each instruction issued. The reorder buffer 18 stores the renamed destination register, the instruction stream number and the priority for the instruction issued.

Semaphores are widely used in software real time operating systems to maintain hardware resources, software resources, task synchronization, mutual exclusion and other uses. Software RTOS's can spend thousands of cycles maintaining semaphores. This invention uses hardware semaphores to reduce or completely eliminate these overhead cycles.

Semaphore unit 20 executes Give, Take, Create, Delete, Flush and other semaphore instructions. Semaphore unit 20 provides a plurality of hardware semaphores, with software providing the support for an essentially unlimited plurality of additional semaphores. In the preferred embodiment, 256 hardware semaphores are implemented. Semaphore unit 20 contains status, control, count, maximum count, owner task and priority (for binary semaphores), blocked-queue-priority, blocked-queue-head-pointer, blocked-queue length, and other registers for each semaphore. Binary and counting semaphores are supported. A Give instruction execution increments the count register for a semaphore up to the maximum count. If a Give execution instruction causes the count register to become non-zero, the highest-priority task on the blocked queue is unblocked and starts execution. A Take execution instruction decrements the count register for a semaphore down to a minimum of zero. If a Take instruction executes when the count is zero, the task associated with the instruction stream executing the Take instruction is either informed that the instruction failed or was blocked, at which time the requesting task is inserted in priority order into a blocked queue for the semaphore as selected by the Take instruction option field. If priority-inversion safety is selected for a binary semaphore by a flag in the semaphore control register and any Task is blocked on the semaphore, the priority of the owner task is boosted to the priority of the highest-priority task on the blocked queue if it is higher than the owner task priority. This provides priority-inversion protection by preventing lower-priority tasks from stalling higher-priority tasks that are blocked while allocating a semaphore.

Issue unit 8 renames both source and destination registers for all instructions using general-purpose registers, and sends the rename information to register rename cache 7. Register rename cache 7 provides a plurality of working registers for temporary, high-speed storage of the integer register contents for the currently executing instruction streams. The register rename cache contains fewer registers than register memory 6. In the preferred embodiment, register rename cache 7 provides 64 registers. When a general-purpose register is renamed, the old contents of the rename register cache entry are transferred into register memory 6 and the contents of the newly renamed general-purpose register are transferred into the rename register cache entry. Rename register cache 7 thus provides high-speed working register storage. Register memory 6 provides lower-speed, architectural storage for the general-purpose registers. This mechanism allows reorder buffer 18 to associate the execution results with the instruction without attaching the task or instruction stream number to the instruction, and allows for a much smaller destination register tag than would otherwise be required. In some applications, the source and destination register tag sizes will not change, allowing for easier application of this invention to existing processors.

Register memory 6 provides storage for the general-purpose integer register sets of all tasks, and maintains the architectural state of the registers. Register memory 6 can be implemented as registers for high-speed access or as a RAM array to reduce chip area and power consumption. Register memory 6 is accessed and controlled by register rename cache 7. In the preferred embodiment, register memory 6 provides 256 sets of 32 registers (8192 total).

The plurality of integer ALUs 13 and 14 receive instructions with priority tags and renamed register identifiers from issue unit 8. These items are stored in a plurality of reservation stations in the integer ALUs. Source register contents are obtained from register rename cache 7 using the renamed register identifiers. When the source register contents become available, an instruction is dispatched from the reservation station to execute. The instructions in the reservation stations are dispatched in priority order, or oldest-first if they are of equal priority. If the source register contents are already available, an instruction can be dispatched without storage in the reservation stations. The integer ALUs performs scalar integer arithmetic and logical operations such as Add, Subtract, Logical And, Logical Or and other scalar instructions. The instruction results are transferred to reorder buffer 18 by a separate result bus for each ALU. Bypass feedback paths allow integer ALUs 13 and 14 and Load/Store 15 to simultaneously recycle the results for further processing while transferring the results to the reorder buffer.

The load/store unit 15 receives instructions with priority tags, renamed register identifiers, and memory access descriptors from issue unit 8. These items are stored in a plurality of reservation stations in the load/store unit. Source register contents are obtained from register rename cache 7 using the renamed register identifiers. When the source register contents are available, an instruction is dispatched from the reservation station for execution. The instructions in the reservation stations are dispatched in priority order, or oldest-first if they are of equal priority. If the source register contents are available, an instruction can be dispatched without storage in the reservation stations. The integer load/store unit executes Load and Store instructions which provide data memory addresses and memory access descriptors to the data cache 16, requesting that data be loaded from or stored into the data cache. The instruction results are transferred to reorder buffer 18 by a result bus for each load/store unit.

Reorder buffer 18 provides temporary storage of results from integer ALUs 13 and 14 and load/store unit 15 in a plurality of storage locations and restores the program order of instruction results that had been completed out of order. The issue unit 8 allocates a storage location in the reorder buffer for each instruction issued. Several storage locations can be allocated simultaneously to support the simultaneous issue of a plurality of instructions. An instruction stream number is stored in each allocated reorder buffer entry to associate results with the appropriate instruction stream. Instruction are retired in-order when all older instructions in the instruction stream have completed. A plurality of instructions can be retired simultaneously.

A memory access descriptor is a unique number that describes a set of memory address ranges, access and sharing privileges, and other control and status information not associated with a particular task. A memory access descriptor can be used by several tasks. Memory access descriptors are used by instruction cache and MMU 11 and data cache and MMU 16 to provide shared, read-only, execute-only, and other partitions of memory required by real-time operating systems.

Instruction cache and MMU 11 provides high-speed temporary storage of instruction streams.

Data cache and MMU 16 provides high-speed temporary storage of data.

On-chip memory 12 provides high-speed random access memory for general-purpose use and for use by the L2 cache 21. L2 cache 21 provides temporary storage of instruction streams and data for the instruction and data caches.

Bus interface unit 17 controls the transfer of data between the processor via the instruction and data caches and on-chip memory 12, and system bus 19.

It will be understood by those skilled in the art that floating-point, single-instruction-multiple-data (SIMD) and other execution units can be included in this invention. Issue unit 8 can issue instructions to floating-point, SIMD and other execution units and their results can be transmitted to reorder buffer 18. Additional floating-point registers, SIMD and other registers can be implemented with separate rename register caches and register memories or used with rename register cache 7 and register memory 6.

It will be understood by those skilled in the art that an instruction prefetcher can be included in this invention that receives task number and priority information from Task control 1 and that commands the instruction cache and MMU 11 to load from memory and save instructions for a plurality of tasks prior to or during their execution.

It will be understood by those skilled in the art that, for each task, a link register for subroutine call and return, a stack-pointer register, a counter register supporting branching and looping of instruction execution, and a timer register for scheduling task execution or other uses can be included in this invention. These registers may be included in Task control 1 or in fetcher 4.

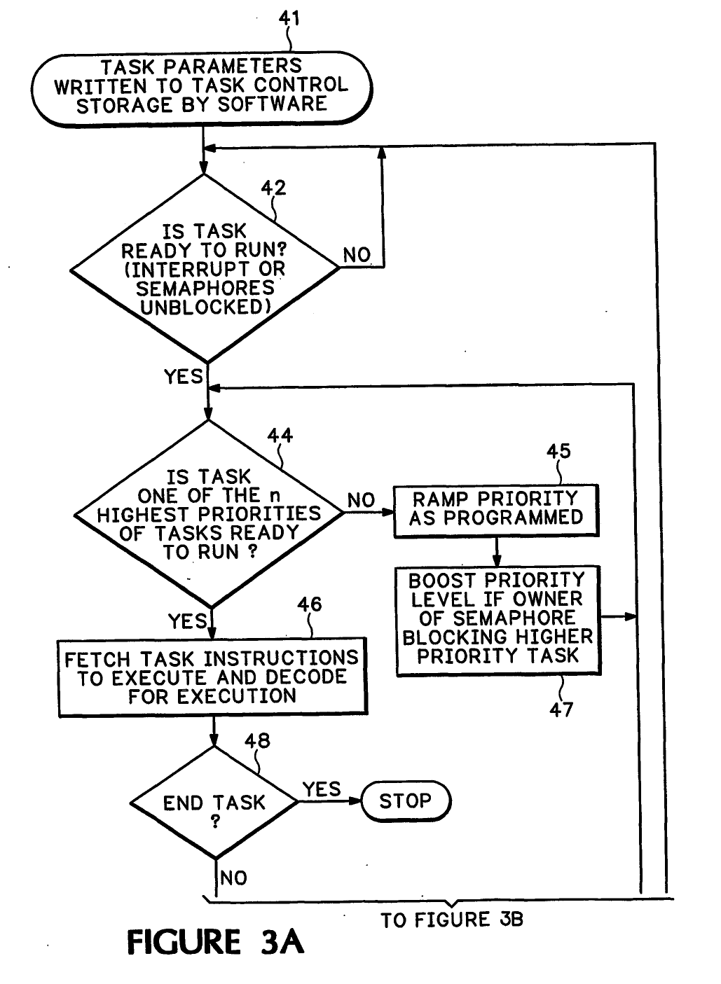

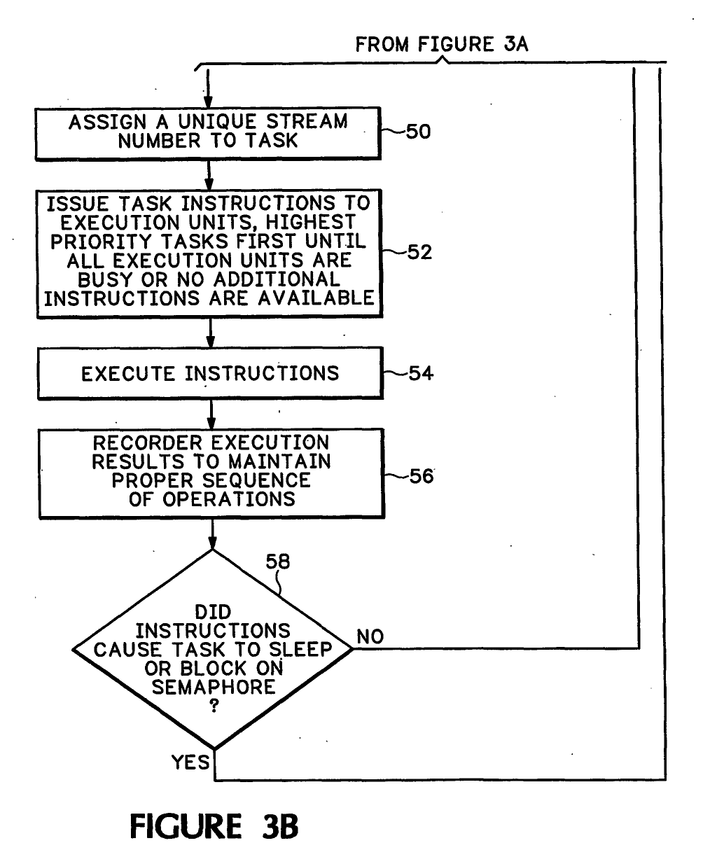

Referring to FIG. 3, the semaphore control unit 20 inserts, deletes and sorts blocked semaphores. FIG. 3 shows a preferred method that “sorts” the blocked tasks as needed. Whenever an operation on a blocked task is required the circuit in FIG. 3 finds the highest priority blocked task for a specific semaphore. A typical use for this is to enable a task that is waiting for a hardware resource to become available, and this hardware resource has used the specific semaphore to signal that it is busy. The FIG. 3 circuit as shown does not enable equal priority tasks blocked on a semaphore to be unblocked in request order, however this could be added with a linked list mechanism. While this is the preferred implementation of the hardware semaphore unit, the semaphore unit can also be arranged as a linked list. This linked list can be inserted into and managed using task priority and task number, sequence number and next task priority, or a blocked bit per task and a bit adder tree to determine the highest priority task in each case.

In operation, priority selector 40 determines the highest priority task and it's current priority. The semaphore unit 20 (FIG. 1) the semaphore number and a blocked semaphore priority request to all tasks. The tasks which are blocked on the specified semaphore number enable their priorities to the priority selector 40. If digital comparator 41 matches the task's blocked semaphore register values to the incoming semaphore number, a non-zero priority is enabled to priority selector 40. Priority selector 40 produces the task number and priority of the highest priority task blocked on the specified semaphore. Tasks not blocked on the specified semaphore send zero priority to the priority selector 40. Task selector 40 can be the same task selector 2 of FIG. 1 if used in a time shared manner. This would allow the unblocked task to get to the fetcher 4 of FIG. 1 as soon as possible.

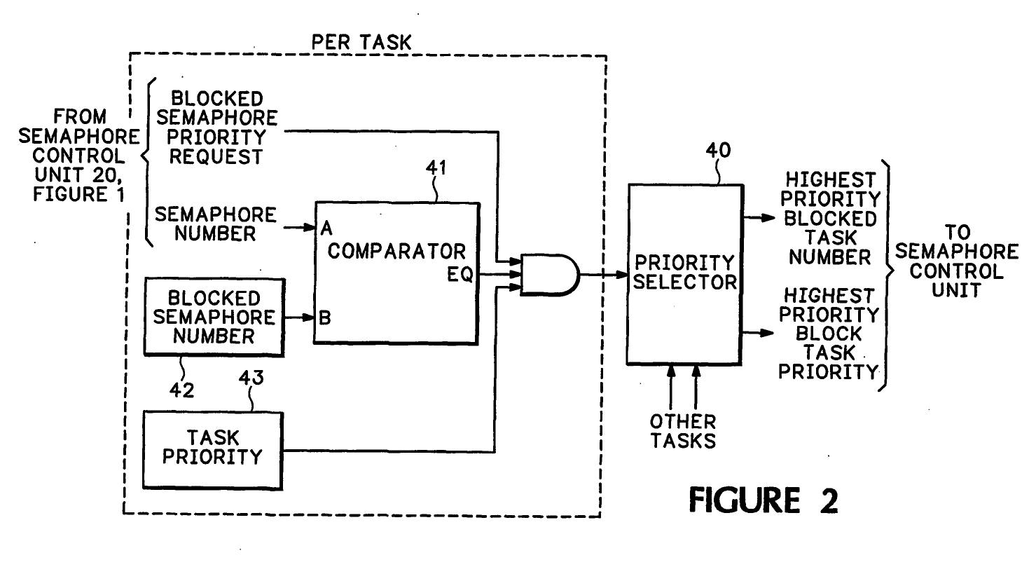

Referring to FIG. 2, a flow chart illustrates the operation of the concurrent multitasking processor of FIG. 1. In block 41 task parameters as described in connection with Task control 1 are written to Task control storage by software. Task control 1 contains priority control data for each task to be run. In block 42 the priority selector 2 determines if the task is ready to run. This is determined simultaneously for each task whose parameters are saved in Task control 1. The task is ready to run if there are no interrupts or semaphores unblocked. If for any task there is a blockage or an interrupt, a loop is completed through the task selector 3 back to Task control 1 until the task is ready to run. At block 44, each task is queried to determine whether it is one of the “n” highest priorities of task ready to run. If the answer is no, its priority is ramped upwards according to a predetermined program. At block 47, the priority level of the task is boosted if it is the owner of a semaphore blocking a higher priority task. Thus, block 47 loops back to block 44 until the task may be one of the “n” highest priorities ready to run. If the answer is yes, at block 46 the fetcher 4 fetches task instructions from memory to execute the task. Fetcher 4 does this by loading the tasks into instruction queues 10. The instructions are then decoded by instruction decode 9. Block 48 determines whether any task contains instructions to end. If so, the processor stops for that task. If no, in block 50 the processor assigns a unique stream number to the task. The stream number contains unique priority data and is assigned by fetcher 4. This priority data is, in turn, provided to Task control 1. In block 52, issue unit 8 issues task instructions to execution units such as integer ALU1 13, integer ALUn 14 and load/store unit 15. Task instructions are issued according to the highest priority until all execution units are loaded or until no further instructions are available. At block 54 instructions are executed by the relevant execution units. Tasks that require a semaphore are provided by the issue unit 8 to semaphore unit 20. If the task is one which may own a semaphore, this information is provided as priority data to Task control 1. After the instructions have been executed at block 54, the results are provided to reorder buffer 18 to maintain the proper sequence of subsequent operations. At block 58 the processor determines through the issue unit 8 and the semaphore unit 20 whether the instructions caused the task to sleep or to block on semaphore. If the answer is no, the processor loops back to block 44 where tasks of the next “n” highest priorities from task selector 3 are examined. If the task is blocked on semaphore, the processor loops back to block 42 where the task is queried in the priority selector to determine whether it is ready to run. Depending on the outcome of this determination, the processor follows the sequence described above.

The processor runs in a continuous loop and stops only when all tasks have ended as indicated by the decision node at block 48.

While various embodiments of the present invention have been described above, it should be understood that they have been represented by way of example, and not limitation. Thus the breath and scope of the present invention should not be limited by any of the above described exemplary embodiments, but should be defined only in accordance with the following claims and their equivalents and such claims as may be later eliminated or added in the course of the submission of the final completed patent application upon this invention. It will be understood by those skilled in the art that various changes in form and detail may be made therein without departing from the spirit and scope of the invention.

The terms and expression which have been employed in the foregoing specification are used therein as terms of description and not of limitation, and there is no intention, in the use of such terms and expressions, of excluding equivalents of the features shown and described or portions thereof, it being recognized that the scope of the invention is to be defined and limited only by the claims which follow and such claims as may be later eliminated or added in the course of the submission of the final completed patent application upon this invention.

We claim:

1. A concurrent multitasking processor for a real-time operating system (RTOS) device comprising:
(a) a plurality of execution units for executing a plurality of tasks simultaneously;
(b) a task selector for comparing priorities of a plurality of tasks and for selecting one or more high priority tasks requesting execution;
(c) an instruction fetcher for retrieving instructions from memory for the tasks selected by the task selector and for storing said instructions for each task in one or more instruction queues; and
(d) an instruction issue unit for attaching priority tags to instructions and for sending instructions from a plurality of said instruction queues to a plurality of execution units for execution.

2. The concurrent multitasking processor of claim 1, further including a register memory for storing register sets for each task in dense, random access memory.

3. The concurrent multitasking processor of claim 2, further including a register rename cache for storing said register sets from said register memory for use by instructions selected for execution by said instruction issue unit.

4. The concurrent multitasking processor of claim 1 wherein said instruction issue unit issues as many instructions as are possible from a highest priority instruction stream and issues instructions from other lower priority instruction streams so as to use any remaining execution capacity.

5. The concurrent multitasking processor of claim 1 wherein said instruction issue unit issues instructions with equal frequency for instruction streams with equal priority.

6. The concurrent multitasking processor of claim 1 wherein each instruction queue contains instructions for only a single stream at a time.

7. In a superscalar processor coupled to a real time operating system having a plurality of execution units for executing a plurality of tasks substantially simultaneously, a task instruction cache for storing in memory a plurality of task instructions, each task instruction having an assigned priority code, the improvement comprising, a task issue unit having outputs coupled to said plurality of execution units for issuing at a predetermined time a plurality of task instructions simultaneously to said execution units, said task instructions being chosen based upon the priority codes of each of the task instructions available for execution at said predetermined time.

8. The improvement of claim 7, further including a priority selector for selecting tasks for execution based upon the highest priority code attached to each task.
